(19) United States
(12) Patent Application Publication
(10) Pub. No.: US 2024/0325853 A1
(43) Pub. Date: Oct. 3, 2024

(54) PLAY CALL GENERATION BASED ON GAME CIRCUMSTANCES

(71) Applicant: Repetix, LLC, Rochester, MN (US)

(72) Inventor: Michael J. Rolih, Rochester, MN (US)

(21) Appl. No.: 18/611,836

(22) Filed: Mar. 21, 2024

Related U.S. Application Data
(60) Provisional application No. 63/492,495, filed on Mar. 28, 2023.

(51) Int. Cl. A63B 71/06; A63B 24/00; A63B 102/18

(52) U.S. Cl. CPC A63B 71/0605; A63B 24/0062; A63B 71/0622; A63B 2024/0068; A63B 2102/18; A63B 2220/05; A63B 2220/807; A63B 2225/50

(57) ABSTRACT

A method includes sending a play call to a first player wearable player electronic device; comparing the play call to sporting activity game circumstance data; based on the comparison and using the sporting activity game circumstance data, generating an adjusted play call; and sending the adjusted play call to at least one of the first player wearable player electronic device and a second, different player wearable player electronic device.

### RELATED APPLICATION

This disclosure claims priority to U.S. provisional patent application No. 63/492,495 filed on Mar. 28, 2023, the entire contents of which are hereby incorporated by reference.

### TECHNICAL FIELD

This disclosure relates generally to using data relating to circumstances of a sporting activity game to generate a play call for that game. Embodiments disclosed herein include devices, systems, and methods directed to automated play call generation using data relating to circumstances of a sporting activity game (e.g., data relating to current, real-time circumstances of the sporting activity game) as well as distribution of the generated play call to one or more wearable player electronic devices, such as to display the generated play call at each such wearable player electronic device.

### BACKGROUND

Sporting activity games, such as baseball, football, and basketball, continue to increase in popularity and sophistication. With the advance of data analytics, opportunities for extracting intelligence from gathered data relating to the sporting activity game have become more widely available and increased the sophistication of sporting activity games at various levels. This includes not just the professional level of the sporting activity, but also the amateur levels, including collegiate and high school levels.

However, to-date, the application of data analytics to various sporting activity games has tended to be generally static and, as such, inadequate in accounting for rapidly changing circumstances of certain types of sporting activity games, particularly those sporting activity games that involve a significant number of variables. Moreover, the current application of data analytics to various sporting activity games makes it difficult to distribute intelligence extracted from this data to one or more players in a timely manner. Because certain, relevant sporting activity game circumstances can change in a matter of seconds, the inability to distribute, to a player, an action discerned from the data in a timely manner can render such distributed action stale and less relevant to the newly changed circumstances of the sporting activity game. This, in turn, tends to decrease the value of data analytics for such sporting activity games and limits the number of applications for data analytics.

### SUMMARY

In general, this disclosure relates to using data relating to circumstances of a sporting activity game to generate a play call, for instance an adjusted play call, for that game in view of the state of one or more game variables at that time. Embodiments disclosed herein include devices, systems, and methods directed to automated play call generation (e.g., automated adjusted play call generation) using data relating to circumstances of a sporting activity game (e.g., data relating to current, real-time circumstances of the sporting activity game). Certain such embodiments also include distribution of the generated play call (e.g., generated adjusted play call) to one or more wearable player electronic devices, such as to display the generated play call (e.g., to display the generated adjusted play call) at each such wearable player electronic device.

Such embodiments disclosed herein can facilitate dynamic use of data analytics as applied to play calls and/or adjusted play calls for sporting activity games. This can allow for applying such data analytics in a manner that can account for rapidly changing circumstances/variables of certain types of sporting activity games. And, this can allow for distribution of a play calls and/or adjusted play call, generated using data relating to a current game circumstance, to one or more wearable player devices in a timely manner that allows the player wearing the wearable player device to execute the received play call and/or adjusted play call routinely and quickly when sporting activity game circumstances/variables change. This, in turn, can provide a useful application of data analytics in a way that can increase the number of applications for sporting activity game data analytics and can increase the value of data analytics for sporting activity games where the circumstances change relatively rapidly.

One embodiment includes a computing device having non-transitory computer-executable instructions that, when executed by programmable processing circuitry of the computing device, cause the programmable processing circuitry of the computing device to: cause a play call to be sent to a first player wearable player electronic device; compare the play call to sporting activity game circumstance data; based on the comparison and using the sporting activity game circumstance data, generate an adjusted play call (e.g., the adjusted play call includes at least one change made to the play call); and send the adjusted play call to at least one of the first player wearable player electronic device and a second, different player wearable player electronic device.

In a further such embodiment, the non-transitory computer-executable instructions, when executed by programmable processing circuitry of the computing device, can cause the programmable processing circuitry of the computing device to: cause the play call to be sent to both a first player wearable player electronic device and a second player wearable player electronic device. Then, after the comparison and generation of the adjusted play call, the adjusted play call can be sent to the second player wearable player electronic device while refraining from sending the adjusted play call to the first player wearable player electronic device.

For example, when applied in the context of a baseball sporting activity game, the first player wearable player electronic device can be configured to be worn by a pitcher while the second player wearable player electronic device can be configured to be worn by a non-pitcher position player in the field of play. In such an example, the play call can include a pitch call (e.g., pitch type, such as one of fastball, curveball, changeup, slider, etc.; and pitch location, such as high and outside, low and outside, high and inside, low and inside, etc.) and/or position player positioning alignment in the field of play (e.g., a specified location within a relative area of the field of play at which a particular position player (e.g., second baseman) should be positioned for the play call) that is caused to be sent to the first player wearable player electronic device that can be configured to be worn by a pitcher and/or to the second player wearable player electronic device that can be configured to be worn by a non-pitcher position player in the field of play. In this example, the pitch call and/or position player positioning alignment in the field of play can then be compared to baseball game circumstance data, such as batter data relating to one or more outcomes of one or more prior at-bats (e.g., when the same pitch call was executed) and/or non-pitcher position player positioning data in the field of play (e.g., as currently positioned, such as specified by the sent play call and/or as previously positioned for one or more prior at-bats). Then, in this example, based on this type of comparison and using this type of baseball game circumstance data, an adjusted play call can be generated by changing at least one aspect of the previously sent play call, such as changing the position player positioning alignment in the field of play for a specified location within a relative area of the field of play at which a particular position player (e.g., second baseman) should be adjusted to be positioned for the play call in view of the baseball game circumstance data to which the play call was compared. And this generated, adjusted play call can be sent at least to the second player wearable player electronic device that can be configured to be worn by a non-pitcher position player in the field of play.

Another embodiment includes a method. This method embodiment includes the steps of: transmitting a first play call from a computing device to a first wearable player electronic device; comparing the first play call to sporting activity game circumstance data, the sporting activity game circumstance data corresponding to a first time of a sporting activity game; based on the comparison and using the sporting activity game circumstance data, generating a first adjusted play call, the first adjusted play call including at least one change relative to the first play call and being different than the first play call; and transmitting the first adjusted play call to the first wearable player electronic device.

In a further embodiment of this method, the sporting activity game circumstance data includes at least one image data frame that includes player positional formation data relative to a field of play and prior to start of a sporting activity play corresponding to the first play call. For example, the at least one image data frame can include first player positional formation data, of a first player, relative to the field of play and relative to a predetermined assigned first positional region for the first player prior to start of the sporting activity play corresponding to the first play call. And the first adjusted play call can be generated to include an adjustment of a position of the first player within the predetermined assigned first positional region for the first player.

For instance, the first adjusted play call can be generated, at least in part, by comparing the at least one image data frame, which includes the player positional formation data, to the predetermined assigned first positional region for the first player to generate the first adjusted play call that includes at least one change in both a specified direction and a specified distance to the position of the first player within the predetermined assigned first positional region for the first player. As one such example, the sporting activity can be a baseball game, and the first adjusted play call can be generated, at least in part, by comparing the at least one image data frame, which includes the player positional formation data, to the predetermined assigned first positional region for the first player using a pitch call for the sporting activity play to determine the at least one change in both the specified direction and the specified distance to the position of the first player within the predetermined assigned first positional region for the first player. For instance, when the pitch call includes a first pitch type and a first pitch location, the first adjusted play call can be generated, at least in part, by comparing the at least one image data frame, which includes the player positional formation data, to the predetermined assigned first positional region for the first player using the first pitch type and the first pitch location to determine the at least one change that includes both the specified direction in a first direction and the specified distance of a first magnitude to the position of the first player within the predetermined assigned first positional region for the first player. Similarly, when the pitch call includes a second, different pitch type and/or a second, different pitch location, the first adjusted play call can be generated, at least in part, by comparing the at least one image data frame, which includes the player positional formation data, to the predetermined assigned first positional region for the first player using the second, different pitch type and the second, different pitch location to determine the at least one change that includes both the specified direction in a second, different direction and/or the specified distance of a second, different magnitude to the position of the first player within the predetermined assigned first positional region for the first player. In some such examples, transmitting the first adjusted play call to the first wearable player electronic device can include transmitting both the specified direction in the second, different direction and the specified distance of the second, different magnitude to the position of the first player within the predetermined assigned first positional region for the first player to the first wearable player electronic device. In some such examples, the first adjusted play call is generated by the computing device, at least in part, using batter data, which includes one or more outcomes of one or more prior at-bats when the pitch call includes the second, different pitch type and the second, different pitch location, to include the at least one change in both the specified direction and the specified distance to the position of the first player within the predetermined assigned first positional region for the first player.

In a further embodiment of this method, the method can additionally include steps of: transmitting the first play call from the computing device to a second, different wearable player electronic device; and transmitting the first adjusted play call to the first wearable player electronic device while refraining from transmitting the first adjusted play call to the second, different wearable player electronic device. In some such examples, based on the comparison and using the sporting activity game circumstance data, a second, different adjusted play call can be generated including at least one change relative to the first play call, and this second adjusted play call can be transmitted to the second wearable player electronic device while refraining from transmitting the second adjusted play call to the first wearable player electronic device. For instance, the first wearable player electronic device can correspond to a pitcher player in the sporting activity game and the second wearable player electronic device can correspond to a non-pitcher positional player in the sporting activity game.

Another embodiment includes a computing device that comprises non-transitory computer-executable instructions. When these non-transitory computer-executable instructions are executed by programmable processing circuitry of the computing device, the programmable processing circuitry of the computing device is caused to: transmit a first play call from the computing device to a first wearable player electronic device; compare the first play call to sporting activity game circumstance data, the sporting activity game circumstance data corresponding to a first time of a sporting activity game; based on the comparison and using the sporting activity game circumstance data, generate a first adjusted play call, the first adjusted play call including at least one change relative to the first play call and being different than the first play call; and transmit the first adjusted play call to the first wearable player electronic device.

In a further embodiment of this computing device, the non-transitory computer-executable instructions, when executed by programmable processing circuitry of the computing device, further cause the programmable processing circuitry of the computing device to: transmit the first play call from the computing device to a second, different wearable player electronic device, and transmit the first adjusted play call to the first wearable player electronic device while refraining from transmitting the first adjusted play call to the second, different wearable player electronic device.

In some such examples, the non-transitory computer-executable instructions, when executed by programmable processing circuitry of the computing device, can further cause the programmable processing circuitry of the computing device to: based on the comparison and using the sporting activity game circumstance data, generate a second adjusted play call, the second adjusted play call including at least one change relative to the first play call and being different than the first adjusted play call; and transmit the second adjusted play call to the second wearable player electronic device while refraining from transmitting the second adjusted play call to the first wearable player electronic device. In one particular example, the sporting activity game circumstance data can include at least one image data frame that includes player positional formation data relative to a field of play and prior to start of a sporting activity play corresponding to the first play call, and the at least one image data frame can include first player positional formation data, of a first player, relative to the field of play and relative to a predetermined assigned first positional region for the first player prior to start of the sporting activity play corresponding to the first play call. The non-transitory computer-executable instructions, when executed by programmable processing circuitry of the computing device, can further cause the programmable processing circuitry of the computing device to generate the first adjusted play call to include an adjustment of a position of the first player in both a specified direction and a specified distance to the position of the first player within the predetermined assigned first positional region for the first player, and the non-transitory computer-executable instructions, when executed by programmable processing circuitry of the computing device, can cause the programmable processing circuitry of the computing device to transmit the first adjusted play call to the first wearable player electronic device while refraining from transmitting the first adjusted play call to the second, different wearable player electronic device.

For example, in some such embodiments, the first wearable player electronic device can correspond to a pitcher and the second wearable player electronic device can correspond to a non-pitcher positional player, the first play call can include a pitch call that includes a first pitch type and a first pitch location, and the non-transitory computer-executable instructions, when executed by programmable processing circuitry of the computing device, can cause the programmable processing circuitry of the computing device to generate the first adjusted play call, at least in part, by comparing the at least one image data frame, which includes the player positional formation data, to the predetermined assigned first positional region for the first player using the first pitch type and the first pitch location to determine the adjustment of the position of the first player in both the specified direction in a first direction and the specified distance of a first magnitude within the predetermined assigned first positional region for the first player. And, in one further such example, the non-transitory computer-executable instructions, when executed by programmable processing circuitry of the computing device, can cause the programmable processing circuitry of the computing device to transmit the first adjusted play call to the second wearable player electronic device while refraining from transmitting the first adjusted play call to first wearable player electronic device prior to execution by the pitcher of the pitch call.

In other additional or alternative examples, the non-transitory computer-executable instructions, when executed by programmable processing circuitry of the computing device, can cause the programmable processing circuitry of the computing device to extract player positional formation data relative to the field of play from the at least one image data frame.

In a further embodiment of this computing device, the non-transitory computer-executable instructions, when executed by programmable processing circuitry of the computing device, cause the programmable processing circuitry of the computing device to: compare one or more image data frames to a predetermined player positioning template that comprises a first predetermined assigned positional region definition for a first player within the field of play and a second predetermined assigned positional region definition for a second player within the field of play; based on the comparison, determine a first current position of the first player relative to the first predetermined assigned positional region definition; generate the first adjusted play call, which comprises an adjustment to the first current position of the first player in both a first specified direction and of a first specified magnitude within the first predetermined assigned positional region definition for the first player using at least: (i) the determined first current position of the first player relative to the first predetermined assigned positional region definition and (ii) the sporting activity game circumstance data that comprises a pitch type and a pitch location of the first play call; transmit the first adjusted play call to the first wearable player electronic device; based on the comparison, determine a second current position of the second player relative to the second predetermined assigned positional region definition; generate a second adjusted play call, which comprises an adjustment to the second current position of the second player in both a second specified direction and of a second specified magnitude within the second predetermined assigned positional region definition for the second player using at least: (i) the determined second current position of the second player relative to the second predetermined assigned positional region definition and (ii) the sporting activity game circumstance data that comprises the pitch type and the pitch location of the first play call; and transmit the second adjusted play call to a second, different wearable player electronic device.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present invention and therefore do not limit the scope of the invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1 is a schematic block diagram of an embodiment of a system for capturing sporting activity game circumstance data.

FIG. 2 is a is a schematic block diagram of an embodiment of a system for transmitting a play call and adjusted play call to one or more of a plurality of wearable player electronic devices for display of a play call data file at each of the one or more of the plurality of wearable player electronic devices. For instance, the system of FIG. 2 could be used in conjunction with the system of FIG. 1 to both capturing sporting activity game circumstance data and use this captured capturing sporting activity game circumstance data to transmit a play call and adjusted play call to one or more of a plurality of wearable player electronic devices.

FIG. 3 is a block diagram of an embodiment of a computing device having non-transitory computer-executable instructions that, when executed by programmable processing circuitry of the computing device, cause the programmable processing circuitry of the computing device to compare a play call to sporting activity game circumstance data and use such data to generate and send an adjusted play call to one of more of plurality of wearable player electronic devices for display of an adjusted play call data file.

FIG. 4 is a flow diagram of an embodiment of a method for using sporting activity game circumstance data to generate an adjusted play call and sending this adjusted play call to one or more of a plurality of wearable player electronic device.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Embodiments are disclosed herein, and illustrated in the accompanying drawings, using baseball as a non-limiting example of a sporting activity game. However, the embodiments disclosed herein can be applied to other types of sporting activity games, such as softball, football, basketball, hockey, volleyball, as other non-limiting examples.

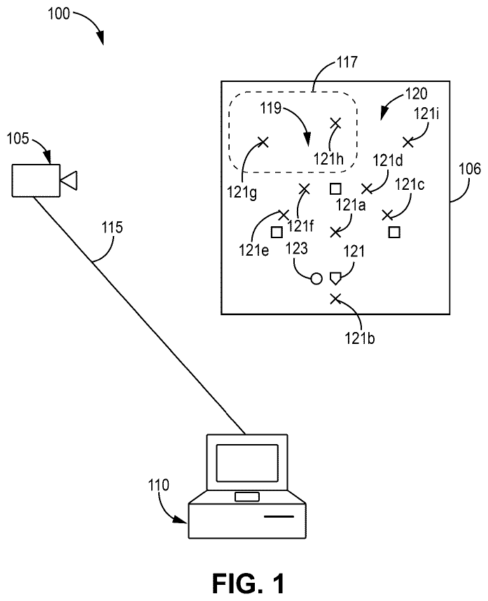

FIG. 1 is a schematic block diagram of an embodiment of a system 100 for capturing sporting activity game circumstance data. Though it is to be noted that in some embodiments within the scope of the present disclosure, sporting activity game circumstance data can additionally or alternatively be received from a third party data provider who itself has procured and created the sporting activity game circumstance data using any number of various data acquisition means.

The system 100 can include a camera 105 and a computing device 110. The camera 105 can be positioned to capture image data of a sporting activity game, for instance a currently in progress game of a sporting activity (e.g., baseball game) before a play (e.g., a pitch) is started and/or while the play is occurring (e.g., while the pitch is thrown and while any subsequent activity resulting from that pitch is occurring, such as while a hit pitch is in play). The camera 105 can be connected to the computing device 110 via a data communication link 115 (e.g., wireless connection), and the camera 105 can capture image data (e.g., video image data) of the sporting activity and transmit this captured image data to the computing device 110. The computing device 110 can be located at or near the location of the sporting activity, or the computing device 110 can be a remote server located remotely from the camera 105 and the sporting activity (e.g., computing device 110 serves as a “cloud”). The image data captured by the camera 105 can be streamed to the computing device 110, or the image data captured by the camera 105 can be uploaded from another device (e.g., remote server; computing device at or near practice session; SD card; etc.) to the computing device 110 at a later time after the captured image data has been saved as a non-transitory image data file. The image data file can be, as illustrative examples, a MP4, MOV, or WMV image data file type.

As such, the computing device 110 can be configured to provide the play call transmission and adjusted play call generation that is based on game circumstances as an on-field, or adjacent-field, capability, or the computing device 110 can serve to provide the play call transmission and adjusted play call generation that is based game circumstances remote from the field of play. The computing device 110 can include non-transitory computer-executable instructions that, when executed by programmable processing circuitry of the computing device 110, cause the programmable processing circuitry of the computing device 110 to perform one or more actions in relation to game circumstance data, including any game circumstance data captured by the camera 105. In some examples, the non-transitory computer-executable instructions stored at the computing device 110 can, when executed by programmable processing circuitry of the computing device 110, cause the programmable processing circuitry of the computing device 110 to transmit one or more commands to the camera 105, such as a begin image capture command, a terminate image capture command, and/or an adjust viewing angle or zoom at the camera 105. For embodiments where the camera 105 is not used, the computing device 110 can include the non-transitory computer-executable instructions that, when executed by programmable processing circuitry of the computing device 110, cause the programmable processing circuitry of the computing device 110 to perform one or more actions in relation to game circumstance data received from a third party data provider who itself has procured and created the sporting activity game circumstance data using any number of various data acquisition means.

FIG. 1 illustrates the system 100, via the camera 105, capturing a frame 106 of image data of player positional formation data 120 relative to a field of play 119 prior to start of the play (e.g., prior to a pitch being thrown by a pitcher 121a). The player positional formation data 120 can include a location of any one or more players 121 relative to a respective, assigned positional region of such player 121 relative to the field of play 119 and/or relative to others of the plurality of players 121. For example, a left fielder 121g may be assigned to a positional region 117, and the player positional formation data 120 for the leftfielder 121g can include a current location of leftfielder 121g relative to the leftfielder's positional region 117 which itself can be defined relative to the field of play 119. The same concept described with respect to the left fielder 121g can apply to any one of more of the other players 121, such as a pitcher 121a, catcher 121b, a first baseman 121c, a second baseman 121d, a third baseman 121e, a shortstop 121f, a center fielder, and a right fielder 121i. The camera 105 can capture image data (e.g., video, picture) of the player positional formation data 120 of the play prior to start of the play (e.g., player positional formation data 120 for one or more players 121, with such player positional formation data 120 being positional data relative to an assigned positional region 117 for that particular player 121), and this captured image data of the player positional formation data 120 of the play prior to start of the play (e.g., frame 106) can be transmitted to the computing device 110.

In some embodiments, the system 100 can be configured to use one or more user-input reference points to inform the captured player positional formation data 120. For example, a user-input reference point that defines an assigned positional region 117 for a particular player 121 can be received, and image data can be captured by the system 100 based on that received user-input reference point that defines the assigned positional region 117 for the particular player 121.

As noted, the illustrated example at FIG. 1 is for a baseball sporting activity game. As applied to the baseball example used here, player positional formation data 120, relative to the field of play 119, can be obtained prior to a pitch being thrown by the pitcher 121a. And, in some additional examples, as applied to the baseball example used here, player positional formation data 120, relative to the field of play 119, can be obtained after the pitch is thrown by the pitcher 121a and after the ball is put (e.g., hit) into the field of play 119 by a batter 123 but before a next, subsequent pitch is thrown by the pitcher 121a.

As is described further herein, as applied to the baseball example used here, various circumstances, or variables, relating to the baseball game can be relevant to a play call that specifies player positional formation data 120 (e.g., a play call that positions one or more players 121 relative to the field of play 119, such as by assigning one or more player positional locations within a particular subregion within the respective assigned positional region 117). For instance, a play call that specifies player positional formation data 120 may differ depending on multiple game circumstances/variables at a given time in the baseball game. These can include, as examples, a pitch call specifying a type of pitch (e.g., fastball, changeup, curveball, etc.) that is to be thrown by the pitcher 121a, a pitch call specifying a location for a type of pitch (e.g., fastball high and inside, changeup low and outside, curveball low and inside, etc.) that is to be thrown by the pitcher 121a, statistics specific to the particular batter 123 (e.g., statistics specific to the particular batter 123 when facing the particular pitcher 121a that is to throw the pitch, statistics specific to the particular batter 123 against a particular type and/or location or a pitch, statistics specific to the particular batter 123 so far in the specific baseball game being played, and/or statistics specific to the particular batter 123 over a predefined period of prior games, etc.) that is to receive the pitch to be throw by the pitcher 121a, a pitch count currently tallied for the particular batter 123 (e.g., three balls and no strikes, etc.) that is to receive the pitch to be throw by the pitcher 121a, and/or a number of outs in the current inning (e.g., two outs in the bottom of the ninth inning).

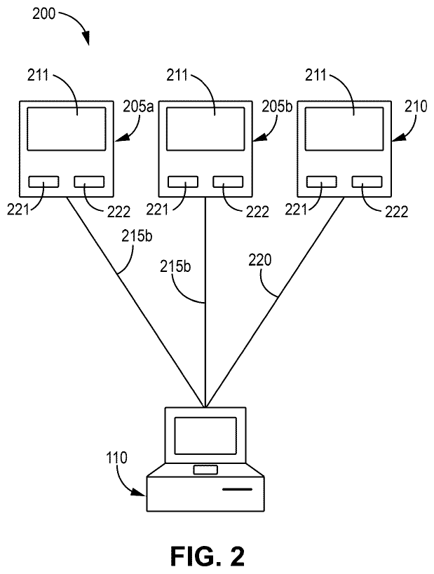

FIG. 2 illustrates a schematic block diagram of an embodiment of a system 200 for transmitting a play call and adjusted play call. The system 200 can include the computing device 110 as well as a plurality of wearable player electronic devices 205a, 205b and a coach portable electronic device 210. The system 200 can be used to transmit a play call, and an adjusted play call (e.g., at a later time), to one or more of the plurality of wearable player electronic devices 205a, 205b for display of a play call data file at each of the one or more of the plurality of wearable player electronic devices 205a, 205b. In particular, the computing device 110 can transmit the play card data file, including a play call data file that specifies player positional formation data for a next pitch to be thrown, to one or more of the plurality of wearable player electronic devices 205a, 205b, via data communications link 215a, 215b, and/or the coach portable electronic device 210, via data communications link 220. The plurality of wearable player electronic devices 205a, 205b and/or the coach portable electronic device 210 can each include a display 211 that is configured to display the play card data file at the display 211.

Each of the wearable player electronic devices 205a, 205b and the coach portable electronic device 210 can include the display 211 as well as one or more user input mechanisms 221, 222. As noted, the display 211 can display the play card data file, including a play call data file that specifies player positional formation data for a next pitch to be thrown, received from the computing device 110. The one or more user input mechanisms 221, 222 can be configured to allow a user of the device 205a, 205b, 210 to provide user input to the respective device 205a, 205b, 210, for instance to change the content of the display 211. In addition, the coach portable electronic device 210 can be in communication with one or more of the wearable player electronic devices 205a, 205b, for instance, through the computing device 110, so that the coach portable electronic device 210 can send a data signal to any one or more of the wearable player electronic devices 205a, 205b. For example, the coach can provide input relating to the specified player positional formation data for a next pitch to be thrown, and/or a play call specifying a next pitch that is to be thrown (e.g., a pitch type and a pitch location) using the one or more user input mechanisms 221, 222, and this input at the coach portable electronic device 210 can be sent to one or more of the wearable player electronic devices 205a, 205b for display at the display 211 of the one or more wearable player electronic devices 205a, 205b.

The coach's portable electronic device 210 can be any one of a variety of device types, such as a cell phone, tablet, or laptop. The coach's portable electronic device 210 can access memory having an electronic playbook application stored thereon. The electronic playbook application can include multiple predetermined player positional formation data sets that specify positional locations for one or more players relative to the field of play which may optionally be linked or segregated with associated notes from the coach and/or segments of the predetermined player positional formation data set being executed as described herein below. The electronic playbook application can further include the ability to add further predetermined player positional formation data set and/or modify existing predetermined player positional formation data sets according to the coach user's preferences.

The electronic playbook application can be a software application that enables the coach to provide various inputs, including the transfer button (e.g., user input mechanism 221) and the review prompt (e.g., user input mechanism 222). The electronic playbook application can further include a practice module which may be integrated with or accessed by the coaching computer module so as to receive and store predetermined player positional formation data sets and related input selected by a coach to be practiced, and further may receive and store time stamped and cut predetermined player positional formation data sets which have been called by the coaching computer module and stored. In addition, the electronic playbook application can further include a playbook generation module which can provide a software interface for a coach to generate one or more portions or one or more predetermined player positional formation data sets, either on the coach's portable electronic device 210 or separately, away from practice on any computer device (not shown) which can access the coaching computer module.

The coach's portable electronic device 210 can enable a coach to transmit a selected, single predetermined player positional formation data set from a plurality of available/stored predetermined player positional formation data sets by actuating the transfer button which will cause the electronic playbook application to transfer the selected play call (e.g., a predetermined player positional formation data set for a next pitch to be thrown) to all individual players and coaches who are wearing wearable player electronic device 205a, 205b that are selected to receive the play call and are registered or otherwise linked to coach's portable electronic device 210 and/or the electronic playbook application, such as through computing device 110. As such, the ability of the computing device 110 to select and transmit one or more predetermined player positional formation data sets and/or one or more pitch calls (e.g., pitch type and pitch location) can allow for more efficient and comprehensive management of variables, and related adjustments to be made as those variables rapidly change. For instance, a coach device 210 may transmit: (i) to at least one non-pitcher positional player (e.g., center fielder) device 205a a first predetermined player positional formation data set that specifies one or more player locations to be occupied for a first pitch (e.g., center fielder to be located at a subregion, e.g. an inner left-hand area, of the center fielder's assigned positional region); and (ii) to the pitcher device 205b a first pitch call (e.g., pitch type and pitch location) to be thrown as a next pitch to the batter. Then, after that next pitch is thrown to the batter, game circumstance will have changed (e.g., the batting count will have changed to reflect that pitch that was throw, the ball may have been put into play and that batter is no longer up at the plate, etc.). The process can then be repeated to account for the current game circumstances as updated based on that most recent pitch such that the coach device 210 may transmit, based on the updated game circumstances: (i) to at least one non-pitcher positional player (e.g., center fielder) device 205a a second, different predetermined player positional formation data set that specifies one or more player locations to be occupied for a second, different pitch (e.g., center fielder to be located at an outer right-hand area of the center fielder's assigned positional region); and (ii) to the pitcher device 205b a second, different pitch call (e.g., pitch type and pitch location) to be thrown as a next pitch to a batter.

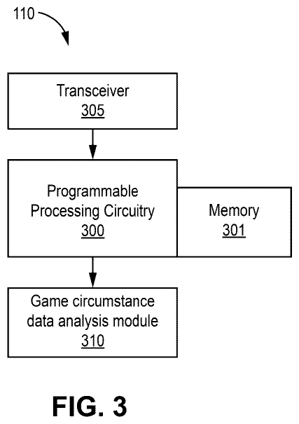

FIG. 3 illustrates a block diagram of the computing device 110 which has non-transitory computer-executable instructions that, when executed by programmable processing circuitry 300 of the computing device 110, cause the programmable processing circuitry 300 of the computing device 110 to, for example, compare a play call to sporting activity game circumstance data and use such data to generate and send an adjusted play call to one of more of plurality of wearable player electronic devices for display of an adjusted play call data file. The computing device 110 can include programmable processing circuitry 300, non-transitory computer-readable storage article (“memory”) 301 coupled to the programmable processing circuity 300, transceiver 305 coupled to the programmable processing circuity 300, and game circumstance data analysis module 310 coupled to the programmable processing circuity 300.

The computing device 110 can have non-transitory computer-executable instructions stored at the game circumstance data analysis module 310. And these stored non-transitory computer-executable instructions, when executed by programmable processing circuitry 300 of the computing device 110, can cause the programmable processing circuitry 300 of the computing device 110 to, for example: cause a play call to be sent to a first player wearable player electronic device; compare the play call to sporting activity game circumstance data; based on the comparison and using the sporting activity game circumstance data, generate an adjusted play call (e.g., the adjusted play call includes at least one change made to the play call); and send the adjusted play call to at least one of the first player wearable player electronic device and a second, different player wearable player electronic device.

As one specific such example, these stored non-transitory computer-executable instructions, when executed by programmable processing circuitry 300 of the computing device 110, can cause the programmable processing circuitry 300 to: cause the play call to be sent to both a first player wearable player electronic device and a second player wearable player electronic device. Then, after the comparison and generation of the adjusted play call, the adjusted play call can be sent to the second player wearable player electronic device while refraining from sending the adjusted play call to the first player wearable player electronic device. For instance, the adjusted play call can include a change in positioning of the second player relative to the field of play (e.g., a change in positioning of the second player relative to the second player's assigned positional region within the field of play) as a result of the comparison of the play call to the current sporting activity game circumstance data, while it could be the case that the comparison of the play call to the current sporting activity game circumstance data does not prompt a change in positioning of the first player relative to the field of play, at least for that specific play call given that current specific sporting activity game circumstance data.

As one example applied in the context of a baseball sporting activity game, the first player wearable player electronic device can be configured to be worn by a pitcher while the second player wearable player electronic device can be configured to be worn by a non-pitcher positional player in the field of play (e.g., second baseman). In such example, the play call can include a pitch call (e.g., a pitch type, such as one of fastball, curveball, changeup, slider, etc.; and a pitch location, such as high and outside, low and outside, high and inside, low and inside, etc.) and/or position player positioning alignment in the field of play (e.g., a specified location within that player's (e.g., second baseman) assigned positional region within the field of play at which that particular position player (e.g., second baseman) should be positioned for that specific pitch call) that is caused to be sent to the first player wearable player electronic device that can be configured to be worn by a pitcher and/or to the second player wearable player electronic device that can be configured to be worn by a non-pitcher position player in the field of play. In this example, the pitch call and/or position player positioning alignment in the field of play can then be compared to baseball game circumstance data, such as batter data relating to one or more outcomes of one or more prior at-bats (e.g., when the same pitch call was executed) and/or non-pitcher position player positioning data in the field of play (e.g., as currently positioned, such as specified by the sent play call and/or as previously positioned for one or more prior at-bats). Then, in this example, based on this type of comparison and using this type of baseball game circumstance data, an adjusted play call can be generated by changing at least one aspect of the previously sent play call, such as changing the position player positioning alignment in the field of play for a specified location within that player's assigned positional region within the field of play at which that particular position player (e.g., second baseman) is to be adjusted to be positioned for the specific play call (e.g., pitch call) just made, but not yet executed, in view of the baseball game circumstance data to which the specific play call was compared. And this generated, adjusted play call can be sent at least to the second player wearable player electronic device that can be configured to be worn by a non-pitcher position player in the field of play.

In certain embodiments, to assist with generating the adjusted play call (e.g., generating the direction and distance to adjust a position player positioning alignment within that player's assigned positional region within the field of play), the computing device 100 can receive, via transceiver 305, image data captured by the camera. The memory 301 and/or game circumstance data analysis module 310 can store non-transitory computer-executable instructions that, when executed by programmable processing circuitry 300, can cause the programmable processing circuitry 300 to generate an adjusted play call (e.g., the adjusted play call includes at least one change made to the previously entered play call) using currently existing sporting activity game circumstance data extracted from the captured image data. Thus, in this way, the stored non-transitory computer-executable instructions, when executed by programmable processing circuitry 300, can cause the computing device 110 to use the received image data to derive currently existing sporting activity game circumstance data (e.g., current position within the field of play, relative to that player's assigned positional region within the field of play) that can be used to determine one or more changes to be made to the previously entered play call (e.g., one or more changes to one or more player locations within the field of play) in view of the entered play call. And, the computing device 110, via the transceiver 305, can transmit a corresponding, adjusted play call data file to one or more of a plurality of wearable player electronic devices and/or a coach device for display of the adjusted play call data file.

The game circumstance data analysis module 310 can store non-transitory computer-executable instructions that, when executed by programmable processing circuitry 300, can cause the programmable processing circuitry 300 to perform an analysis that compares one or more frames of captured image data to a predetermined positioning template. The predetermined positioning template can include predetermined assigned positional region definitions for one or more specific players within the field of play. For instance, the predetermined positioning template can include a predetermined assigned positional region definition for a second baseman within the field of play and similarly include a predetermined assigned positional region definition for one or more other positional players within the field of play. The comparison of one or more frames of captured image data to the predetermined positioning template can cause the game circumstance data analysis module 310 to determine a specific position of a given positional player relative to that player's predetermined assigned positional region definition. Then, the game circumstance data analysis module 310 can use this determined specific position of the given positional player relative to that player's predetermined assigned positional region definition to generate an adjustment (e.g., a specified direction and specified distance to adjust in that specified direction) to that player's positioning within that player's predetermined assigned positional region definition.

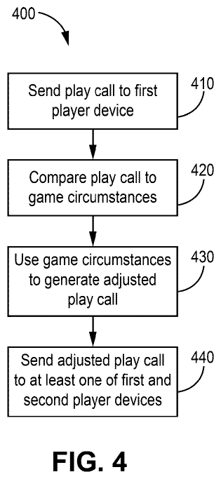

FIG. 4 illustrates a flow diagram of an embodiment of a method 400 for using sporting activity game circumstance data to generate an adjusted play call and sending this adjusted play call to one or more of a plurality of wearable player electronic device. The method 400 can be executed at any one or more devices, including execution of the method 400 at the computing device 110.

At step 410, the method 400 includes sending a play call to a first player wearable player electronic device. The play call can include a specified pitch call (e.g., including a pitch type, such as one of fastball, curveball, changeup, slider, etc.; and pitch location, such as high and outside, low and outside, high and inside, low and inside, etc.) and/or specified position player positioning alignment in the field of play (e.g., a specified location within a relative area (e.g., within a respective player's assigned positional region) of the field of play at which a particular position player (e.g., second baseman) should be positioned for the play call.

At step 420, the method 400 includes comparing the play call to sporting activity game circumstance data. Comparing the play call to sporting activity game circumstance data can include comparing the specified pitch call (e.g., specifying a type of pitch (e.g., fastball, changeup, curveball, etc.) that is to be thrown by the pitcher and/or a location for a type of pitch (e.g., fastball high and inside, changeup low and outside, curveball low and inside, etc.) that is to be thrown by the pitcher) and/or specified position player positioning alignment in the field of play of the play call to the state of current game variables/circumstances, such as one or more of statistics specific to the particular batter at the plate (e.g., statistics specific to that batter when facing the particular pitcher that is to throw the pitch, statistics specific to that batter against a particular type and/or location or a pitch, statistics specific to that batter when that batter is facing the current pitch count, statistics specific to that batter so far in the specific baseball game being played (e.g., the batter's swinging bat speed is higher in the specific baseball game being played than in one or more past base games that batter played), statistics specific to that particular batter over a predefined period of prior games, etc.), a pitch count currently tallied for the particular batter that is to receive the pitch to be throw by the pitcher, and/or a number of outs in the current inning. The current state of any one or more of these game variables/circumstances can impact the probability of a potential outcome of the next pitch to be throw (in view of the specifics of the play call for that next pitch to be thrown, e.g., fastball high and inside), for instance, the probability that the particular batter hits the ball in a certain direction or to a certain region of the field of play. For instance, a particular batter may have statistics from prior at-bats indicating the particular batter is disproportionately likely to hit the ball to the right side of the field when the play call is a fastball outside and/or other game variables circumstances are currently present (e.g., the pitch count has more balls than strikes).

At step 430, the method 400 includes, based on the comparison and using the sporting activity game circumstance data, generating an adjusted play call (e.g., the adjusted play call includes at least one change made to the play call). For example, based on this type of comparison and using the one or more types of baseball game circumstance/variable data described herein, an adjusted play call can be generated. In one specific such example, the adjusted play call can be generated by changing at least one aspect of the previously sent play call, such as changing at least one position player positioning alignment, relative to an assigned position region for that player in the field of play, to a different specified location, relative to the assigned position region for that player in the field of play, at which that player (e.g., second baseman) should be located given the probabilities of outcomes of the to-be-made pitch in view of the current circumstances/variables.

At step 440, the method 400 includes sending the adjusted play call to at least one of the first player wearable player electronic device and a second, different player wearable player electronic device. The adjusted play call sent at step 440 can be displayed at a user interface display at one of more wearable electronic devices that receive the adjusted play call so that the player wearing the wearable electronic device can visualize at the display a specified adjustment to be made to that player's current positioning in the field of play (e.g., visualize both a direction and distance that player is to more from his current position in the field of play).

Various examples of the disclosure have been described. Any combination of the described systems, operations, or functions is contemplated. These and other examples are within the scope of the following claims.

What is claimed is:

1. A method comprising the steps of:
transmitting a first play call from a computing device to a first wearable player electronic device;
comparing the first play call to sporting activity game circumstance data, the sporting activity game circumstance data corresponding to a first time of a sporting activity game;
based on the comparison and using the sporting activity game circumstance data, generating a first adjusted play call, the first adjusted play call including at least one change relative to the first play call and being different than the first play call; and
transmitting the first adjusted play call to the first wearable player electronic device.

2. The method of claim 1, wherein the sporting activity game circumstance data comprises at least one image data frame that includes player positional formation data relative to a field of play and prior to start of a sporting activity play corresponding to the first play call.

3. The method of claim 2,
wherein the at least one image data frame comprises first player positional formation data, of a first player, relative to the field of play and relative to a predetermined assigned first positional region for the first player prior to start of the sporting activity play corresponding to the first play call, and
wherein the first adjusted play call is generated to include an adjustment of a position of the first player within the predetermined assigned first positional region for the first player.

4. The method of claim 3, wherein the first adjusted play call is generated, at least in part, by comparing the at least one image data frame, which includes the player positional formation data, to the predetermined assigned first positional region for the first player to generate the first adjusted play call that includes at least one change in both a specified direction and a specified distance to the position of the first player within the predetermined assigned first positional region for the first player.

5. The method of claim 4,
wherein the sporting activity is a baseball game, and
wherein the first adjusted play call is generated, at least in part, by comparing the at least one image data frame, which includes the player positional formation data, to the predetermined assigned first positional region for the first player using a pitch call for the sporting activity play to determine the at least one change in both the specified direction and the specified distance to the position of the first player within the predetermined assigned first positional region for the first player.

6. The method of claim 5,
wherein, when the pitch call comprises a first pitch type and a first pitch location, generating the first adjusted play call, at least in part, by comparing the at least one image data frame, which includes the player positional formation data, to the predetermined assigned first positional region for the first player using the first pitch type and the first pitch location to determine the at least one change comprising both the specified direction in a first direction and the specified distance of a first magnitude to the position of the first player within the predetermined assigned first positional region for the first player.

7. The method of claim 6,
wherein, when the pitch call comprises a second, different pitch type and/or a second, different pitch location, generating the first adjusted play call, at least in part, by comparing the at least one image data frame, which includes the player positional formation data, to the predetermined assigned first positional region for the first player using the second, different pitch type and the second, different pitch location to determine the at least one change comprising both the specified direction in a second, different direction and/or the specified distance of a second, different magnitude to the position of the first player within the predetermined assigned first positional region for the first player.

8. The method of claim 7,
wherein transmitting the first adjusted play call to the first wearable player electronic device comprises transmitting both the specified direction in the second, different direction and the specified distance of the second, different magnitude to the position of the first player within the predetermined assigned first positional region for the first player to the first wearable player electronic device.

9. The method of claim 7,
wherein the first adjusted play call is generated by the computing device, at least in part, using batter data, which comprises one or more outcomes of one or more prior at-bats when the pitch call comprises the second, different pitch type and the second, different pitch location, to include the at least one change in both the specified direction and the specified distance to the position of the first player within the predetermined assigned first positional region for the first player.

10. The method of claim 1, further comprising:
transmitting the first play call from the computing device to a second, different wearable player electronic device; and
transmitting the first adjusted play call to the first wearable player electronic device while refraining from transmitting the first adjusted play call to the second, different wearable player electronic device.

11. The method of claim 10, further comprising:
based on the comparison and using the sporting activity game circumstance data, generating a second adjusted play call, the second adjusted play call including at least one change relative to the first play call and being different than the first adjusted play call; and
transmitting the second adjusted play call to the second wearable player electronic device while refraining from transmitting the second adjusted play call to the first wearable player electronic device.

12. The method of claim 11,
wherein the first wearable player electronic device corresponds to a pitcher player in the sporting activity game, and
wherein the second wearable player electronic device corresponds to a non-pitcher positional player in the sporting activity game.

13. A computing device comprising non-transitory computer-executable instructions that, when executed by programmable processing circuitry of the computing device, cause the programmable processing circuitry of the computing device to:
transmit a first play call from the computing device to a first wearable player electronic device;
compare the first play call to sporting activity game circumstance data, the sporting activity game circumstance data corresponding to a first time of a sporting activity game;
based on the comparison and using the sporting activity game circumstance data, generate a first adjusted play call, the first adjusted play call including at least one change relative to the first play call and being different than the first play call; and
transmit the first adjusted play call to the first wearable player electronic device.

14. The device of claim 13, wherein the non-transitory computer-executable instructions, when executed by programmable processing circuitry of the computing device, further cause the programmable processing circuitry of the computing device to:
transmit the first play call from the computing device to a second, different wearable player electronic device, and
transmit the first adjusted play call to the first wearable player electronic device while refraining from transmitting the first adjusted play call to the second, different wearable player electronic device.

15. The device of claim 14, wherein the non-transitory computer-executable instructions, when executed by programmable processing circuitry of the computing device, further cause the programmable processing circuitry of the computing device to:
based on the comparison and using the sporting activity game circumstance data, generate a second adjusted play call, the second adjusted play call including at least one change relative to the first play call and being different than the first adjusted play call; and
transmit the second adjusted play call to the second wearable player electronic device while refraining from transmitting the second adjusted play call to the first wearable player electronic device.

16. The device of claim 15,
wherein the sporting activity game circumstance data comprises at least one image data frame that includes player positional formation data relative to a field of play and prior to start of a sporting activity play corresponding to the first play call,
wherein the at least one image data frame comprises first player positional formation data, of a first player, relative to the field of play and relative to a predetermined assigned first positional region for the first player prior to start of the sporting activity play corresponding to the first play call,
wherein the non-transitory computer-executable instructions, when executed by programmable processing circuitry of the computing device, cause the programmable processing circuitry of the computing device to generate the first adjusted play call to include an adjustment of a position of the first player in both a specified direction and a specified distance to the position of the first player within the predetermined assigned first positional region for the first player, and
wherein the non-transitory computer-executable instructions, when executed by programmable processing circuitry of the computing device, cause the programmable processing circuitry of the computing device to transmit the first adjusted play call to the first wearable player electronic device while refraining from transmitting the first adjusted play call to the second, different wearable player electronic device.

17. The device of claim 16,
wherein the first wearable player electronic device corresponds to a pitcher and the second wearable player electronic device corresponds to a non-pitcher positional player, and in
wherein the first play call comprises a pitch call that includes a first pitch type and a first pitch location, and
wherein the non-transitory computer-executable instructions, when executed by programmable processing circuitry of the computing device, cause the programmable processing circuitry of the computing device to generate the first adjusted play call, at least in part, by comparing the at least one image data frame, which includes the player positional formation data, to the predetermined assigned first positional region for the first player using the first pitch type and the first pitch location to determine the adjustment of the position of the first player in both the specified direction in a first direction and the specified distance of a first magnitude within the predetermined assigned first positional region for the first player.

18. The device of claim 17, wherein the non-transitory computer-executable instructions, when executed by programmable processing circuitry of the computing device, cause the programmable processing circuitry of the computing device to transmit the first adjusted play call to the second wearable player electronic device while refraining from transmitting the first adjusted play call to first wearable player electronic device prior to execution by the pitcher of the pitch call.

19. The device of claim 16, wherein the non-transitory computer-executable instructions, when executed by programmable processing circuitry of the computing device, cause the programmable processing circuitry of the computing device to extract player positional formation data relative to the field of play from the at least one image data frame.

20. The device of claim 13, wherein the non-transitory computer-executable instructions, when executed by programmable processing circuitry of the computing device, cause the programmable processing circuitry of the computing device to:
compare one or more image data frames to a predetermined player positioning template that comprises a first predetermined assigned positional region definition for a first player within the field of play and a second predetermined assigned positional region definition for a second player within the field of play;
based on the comparison, determine a first current position of the first player relative to the first predetermined assigned positional region definition;
generate the first adjusted play call, which comprises an adjustment to the first current position of the first player in both a first specified direction and of a first specified magnitude within the first predetermined assigned positional region definition for the first player using at least: (i) the determined first current position of the first player relative to the first predetermined assigned positional region definition and (ii) the sporting activity game circumstance data that comprises a pitch type and a pitch location of the first play call;
transmit the first adjusted play call to the first wearable player electronic device;
based on the comparison, determine a second current position of the second player relative to the second predetermined assigned positional region definition;
generate a second adjusted play call, which comprises an adjustment to the second current position of the second player in both a second specified direction and of a second specified magnitude within the second predetermined assigned positional region definition for the second player using at least: (i) the determined second current position of the second player relative to the second predetermined assigned positional region definition and (ii) the sporting activity game circumstance data that comprises the pitch type and the pitch location of the first play call; and
transmit the second adjusted play call to a second, different wearable player electronic device.
